(19) United States
(12) Patent Application Publication
(10) Pub. No.: US 2012/0257851 A1
(43) Pub. Date: Oct. 11, 2012

(54) OPTICAL LOGIC GATES USING SLOW-LIGHT BASED COUPLED PHOTONIC CRYSTAL WAVEGUIDES

(75) Inventors: Ahmed Sharkawy, Newark, DE (US); Mathew J. Zablocki, Newark, DE (US); Dennis W. Prather, Newark, DE (US)

(73) Assignee: Lumilant, Inc., Newark, DE (US)

(21) Appl. No.: 13/413,188

(22) Filed: Mar. 6, 2012

Related U.S. Application Data
(60) Provisional application No. 61/449,823, filed on Mar. 7, 2011.

(51) Int. Cl. G02B 6/12

(52) U.S. Cl. 385/14

(57) ABSTRACT

An optical logic gate may be composed of a host material having air holes disposed therein and having parallel optical waveguides formed therein.

### CROSS-REFERENCE TO RELATED APPLICATION

This application claims priority to U.S. Provisional Patent Application No. 61/449,823, filed on Mar. 7, 2011, and incorporated herein by reference in its entirety.

### FIELD OF ENDEAVOR

Embodiments of the invention may relate to techniques for implementation of optical logic gates.

### BACKGROUND

While there may presently be implementations of optical logic gates, such implementations may rely on nonlinear material properties, coupled waveguide theory, and/or photonic crystal theory. Present technologies may need to rely on electronic signal routing, occupying large chip areas, which may lead to signal delays and associated latency, and may also reduce available chip area for signal processing.

### SUMMARY OF EMBODIMENTS OF THE INVENTION

Various embodiments of the invention may utilize a chip-scale optical gate for optical signal processing.

### BRIEF DESCRIPTIONS OF THE DRAWINGS

Various embodiments of the invention will now be described in conjunction with the attached drawings, in which:

FIG. 1 shows an exemplary implementation of various embodiments of the invention;

FIG. 2-4 show various modifications of implementations, according to various embodiments of the invention;

FIG. 5 shows a table of different logic gates that may be implemented using various embodiments of the invention; and

FIG. 6 shows a further embodiment of the invention.

### DESCRIPTION OF EMBODIMENTS OF THE INVENTION

Various embodiments of the invention may involve a chip-scale implementation of one or more nano-scale optical logic gates using slow light based coupled photonic crystal (PhC) waveguides. In such a system, coupled photonic crystal theory may be used to achieve photonic logic functionalities. Optical signal distribution through the chip may be performed using a planar routing fabric. Active routing may be achieved using P-I-N structures to modulate the coupling between two coupled photonic crystal waveguides designed to operate in a slow light regime.

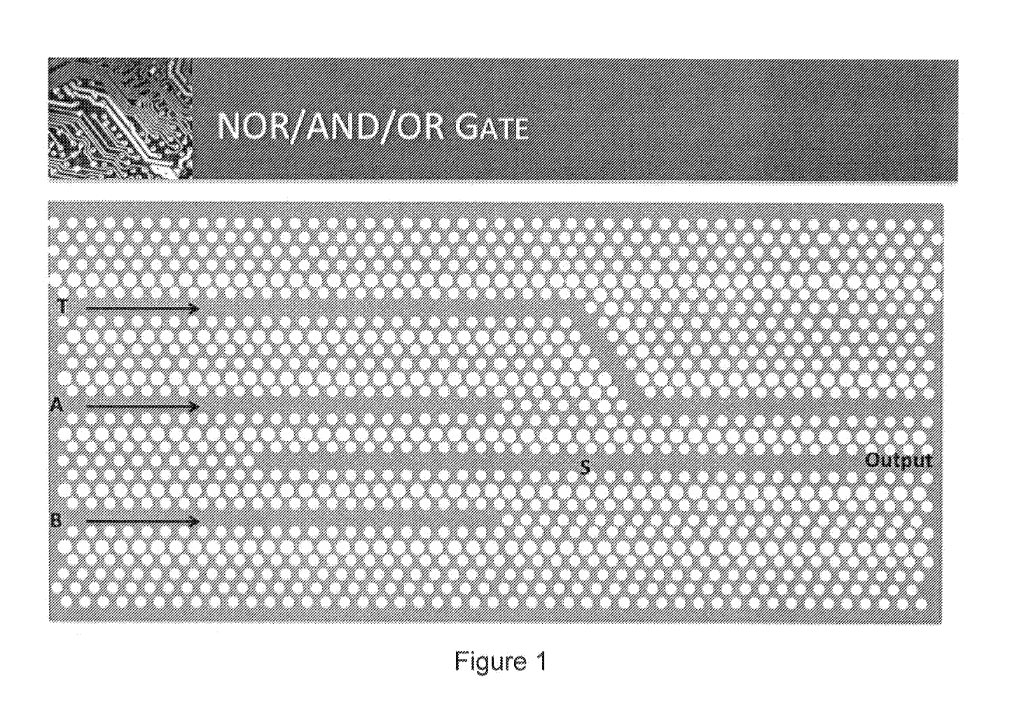

A logic gate may be constructed in a coupled photonic crystal waveguide system. The photonic crystal shown, e.g., in FIG. 1, may be composed of a periodic arrangement of air voids in a silicon host material; the air holes are shown in the figure by the white circles, while the grey background shows the silicon host material. The refractive index of the silicon may be approximately 3.47, while the refractive index of the air voids may be approximately 1.0. The entire structure may rest, e.g., on a thick oxide substrate to have a Silicon-on-Insulator (SOI) cross-sectional structure.

A coupled photonic crystal waveguide system may be formed by bringing multiple single mode waveguides in close proximity of each other. When two waveguides are placed in close proximity in such a way that the evanescent tails of their respective modes overlap, energy of the electromagnetic wave propagating within one of them can be partially, or completely, transferred to the other. Such an arrangement is referred to as “coupled dielectric waveguides,” or a “directional coupler.” Since line defects in photonic crystals may exhibit guiding properties similar to those of dielectric waveguides, when two such defects are placed parallel in close proximity, light launched into one of them may couple to the other.

Thus, coupled photonic-crystal waveguides (CPhCW), which may be formed by two closely spaced parallel waveguides, may provide a means of transferring an electromagnetic wave from one waveguide to another. Such a system can be used for a variety of applications, which may include, but are not limited to, switching, power division, and/or frequency/polarization filtering. For example, to which the invention is not limited, if an electromagnetic wave is initially propagated along a particular line defect/waveguide, and if two parallel line defects/waveguides are also provided, the energy may be coupled from the central line defect/waveguide to the two surrounding line defects/waveguides (and vice versa, if the same configuration of three line defects/waveguides continues long enough; the energy may continue to oscillate between being carried by the central line defect/waveguide and being carried by the surrounding line defects/waveguides). Similarly, if electromagnetic waves are initially propagated along the two respective line defects/waveguides that surround a third, central line defect/waveguide, the energies from the surrounding line defects/waveguides may be transferred to and combined in the central line defect/waveguide. Consequently, by adjusting lengths and configurations of parallel line defects/waveguides, one may obtain different effects, such as summing, splitting, etc., which may be used to obtain various logical and/or other functions. Below, the concept of coupled photonic-crystal waveguides is examined in more detail, and several applications are discussed.

As noted above, an apparatus according to an embodiment of the invention may utilize so-called “slow light.” Slow light may be obtained by increasing the hole void dilation surrounding the photonic crystal waveguide, and as such the overall coupling length necessary for the electromagnetic wave interaction between the coupled waveguide structure may be significantly decreased and may thus provide compact device design.

Using such techniques, it may be possible to construct two fundamental logic gates (e.g., NOR and AND). Additional logic gates and functionalities can be realized by utilizing conventional Boolean algebra. The gate design may be scaled laterally and/or vertically to attain a required number of logic functionalities. Various embodiments of the invention may not rely on the nonlinear properties of materials to realize optical functionalities as commonly known.

In present embodiments, a threshold optical signal may be used to control the gate operation between a NOR and an AND gate. For example, in some implementations, a zero threshold signal may result in the structure operating as a NOR gate, while a non-zero threshold value may result in the structure operating as an AND gate. The threshold value may be controlled using a P-I-N structure.

FIG. 1 contains an example of such an implementation according to an embodiment of the invention. FIG. 1 shows inputs A, B, and T, and an output, as well as an intermediate signal S. A and B may be input optical signals to be applied to the logic gate, while T may represent a threshold optical signal. Such a structure may operate as follows.

In the following discussion, if a signal, e.g., A or B, is “high” or “ON,” the representation used in the following equations is “A” or “B”. The intermediate signal S may represent the interference between the inputs A and B. When A and B are in phase, they may constructively interfere, and as such, S may represent the sum of both signals S=A+B. When B is out of phase (180 degrees) with A, the two signals may destructively interfere; as such, S may represent the difference of the two signals. In various implementations of embodiments of the invention, without loss of generality, A and B may be understood as being in phase, while the threshold control signal T may take values of T=−(A+B), T=A or T=0 respectively.

When both input signals, A and B, are OFF or Optical Low (A=B=0), the sum of the two signals may be represented as S=0. When A is ON or Optical High and B is OFF or Optical Low (A=A, B=0) the sum of the two signals may be represented as S=A. When B is ON or Optical High and A is OFF or Optical Low (B=B, A=0), the sum of the two signals may be represented as S=B. When both input signals are at ON or Optical High (A=A, B=B) the sum of the two signals S=A+B.

At the gate output (labeled “Output” in FIG. 1), a photo detector with a threshold±(A+B) may be used to convert the optical signal to an electrical signal. In such a case, an input signal to the photodetector with less than A+B magnitude may be considered as a ZERO, and an input signal to the photodetector having magnitude equal to or greater than A+B may be considered a ONE. Depending upon the value of T, such a device may operate in different ways, as follows:

### Case 1: T=0

If the threshold signal is set to 0, the sum signal may then remain unmodified to produce the output 0 for (A, B)=(0,0), the output A for (A,B)=(A,0), the output B for (A,B)=(0,B), or the output A+B for (A,B)=(A,B). At the photodetector (PD) output this may then produce an electrical output signal reflected by the following table, where “PD”represents the photodetector output result, as discussed above:

| Input A | Input B | S | PD |
|---|---|---|---|
| 0 | 0 | 0 | 0 |
| A | 0 | A | 0 |
| 0 | B | B | 0 |
| A | B | A + B | 1 |

This corresponds to a truth table for an AND gate.

### Case 2: T=A

If the threshold signal is set to A, the signal at the input to the photodetector may correspond to A for (A, B)=(0,0), the output 2A for (A,B)=(A,0), or the output A+B for (A,B)=(0,B), or the output 2A+B for (A,B)=(A,B). At the photodetector (PD) output, this may then produce an electrical output signal reflected by the following table:

| Input A | Input B | S | PD |
|---|---|---|---|
| 0 | 0 | A | 0 |
| A | 0 | 2A | 1 |
| 0 | B | A + B | 1 |
| A | B | 2A + B | 1 |

This, in turn, corresponds to the truth table for an OR gate.

### Case 3: T=−(A+B)

If the threshold signal is set to −(A+B), the sum signal at the input to the photodetector may correspond to −(A+B) for (A, B)=(0,0), the output −B for (A,B)=(A,0), the output −A for (A,B)=(0,B), or the output 0 for (A,B)=(A,B). At the photodetector (PD) output, this may then produce an electrical output signal reflected by the following table:

| Input A | Input B | S | PD |
|---|---|---|---|
| 0 | 0 | −(A + B) | 1 |
| A | 0 | −B | 0 |
| 0 | B | −A | 0 |
| A | B | 0 | 0 |

This corresponds to the truth table for a NOR gate.
A summary of the previous three cases is shown in the table below

| | | | T = −(A + B) | | T = A | | T = 0 | |
|---|---|---|---|---|---|---|---|---|
| Input A | Input B | S | NOR GATE | | OR GATE | | AND GATE | |
| 0 | 0 | 0 | −(A + B) | 1 | A | 0 | 0 | 0 |
| A | 0 | A | −B | 0 | 2A | 1 | A | 0 |
| 0 | B | B | −A | 0 | A + B | 1 | B | 0 |
| A | B | A + B | 0 | 0 | 2A + B | 1 | A + B | 1 |

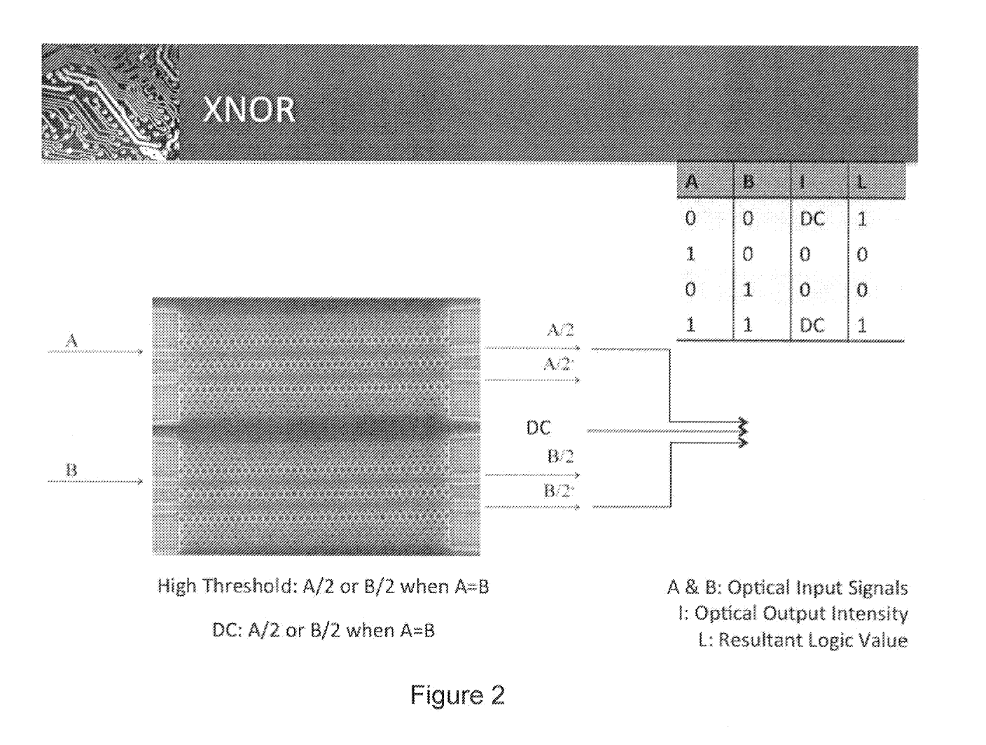

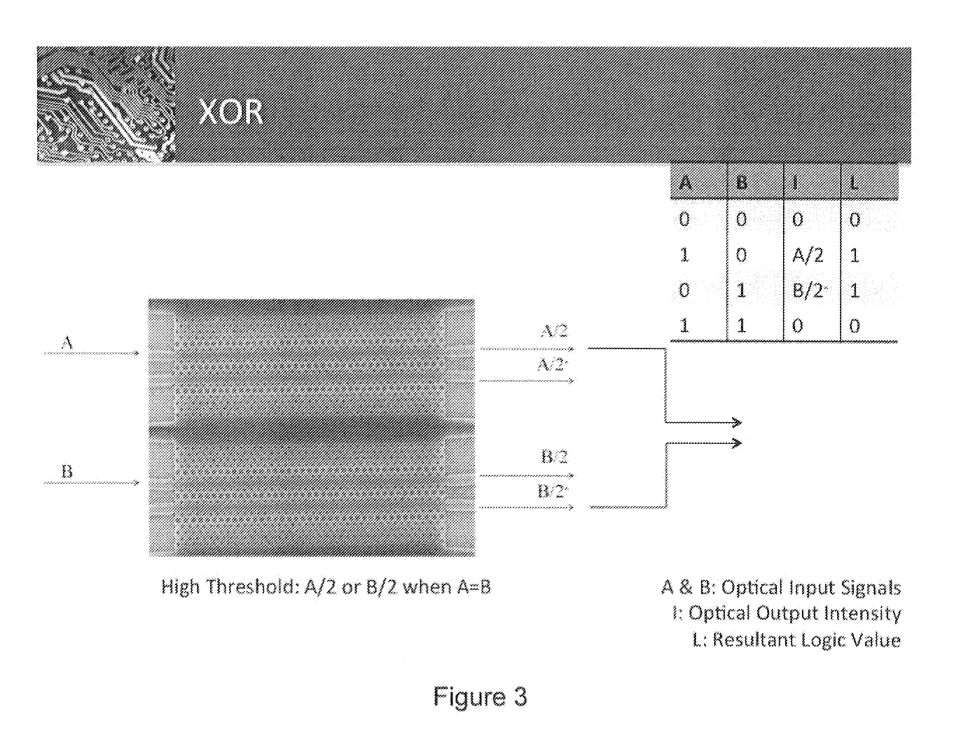

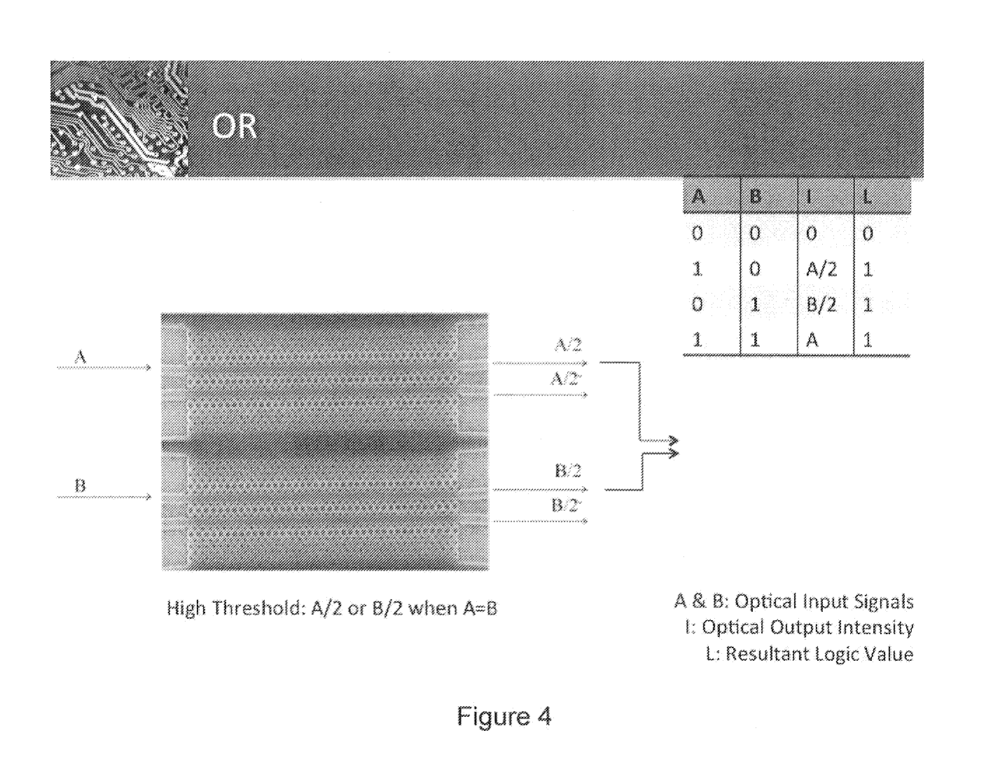

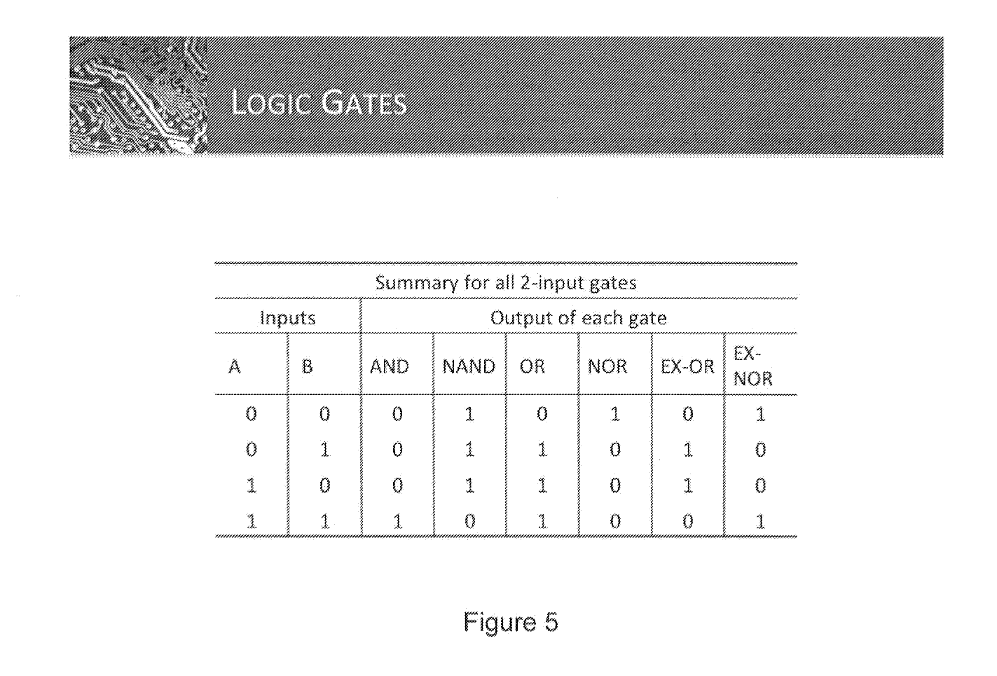

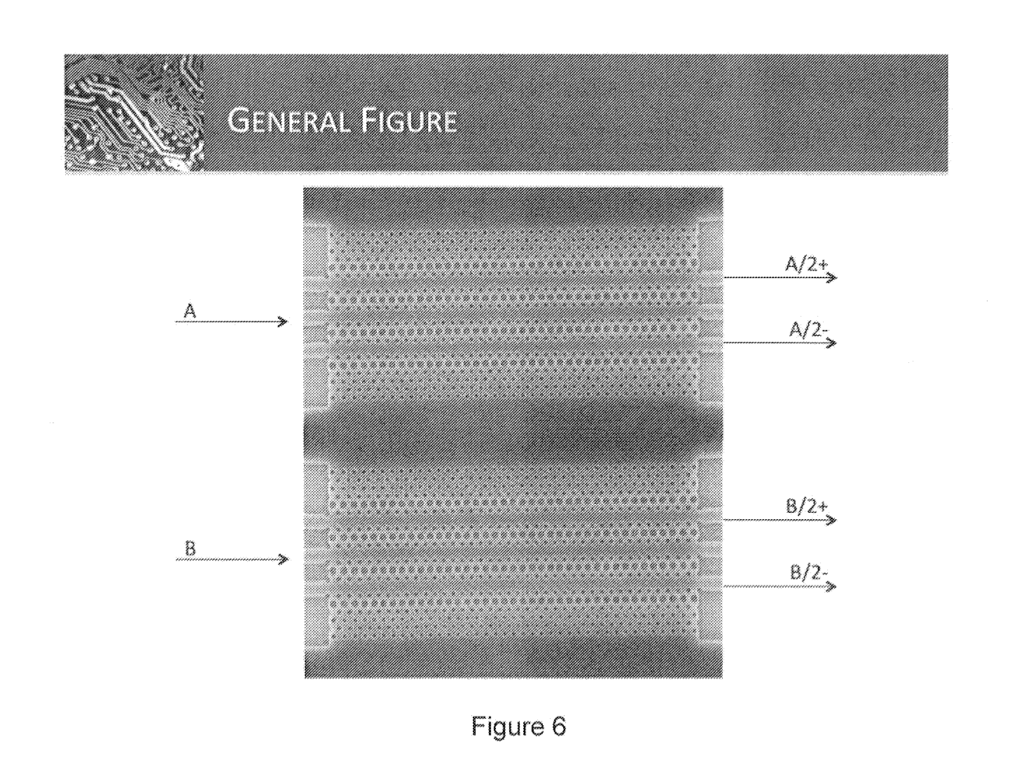

FIGS. 2-4 show how the above gate structure, inputs, and/or outputs may be modified to obtain further logic functions, according to various embodiments of the invention. FIG. 6 shows a general figure reflecting the basic inputs and outputs that may pertain to the structure shown in FIGS. 2-4, and as shown in FIGS. 2-4, various combinations of the outputs may be used to obtain various logic functions. FIG. 5 summarizes the truth tables of a number of basic logic gates that may be implemented. However, as noted above, using Boolean algebra, one may construct various different logic functions, including all of those in the above table, based on combinations of AND and NOR gates.

In some embodiments, the photonic crystal waveguide subsystem may have two photonic crystal waveguides, which may be, for example, 5 microns long. These photonic crystal waveguides may be designed to operate in a slow light regime.

Various embodiments of the invention may also comprise cascaded versions of the various gates constructed using the techniques described above, which may be used, e.g., to implement more complex logic.

It will be appreciated by persons skilled in the art that the present invention is not limited by what has been particularly shown and described hereinabove. Rather the scope of the present invention includes both combinations and sub-combinations of various features described hereinabove as well as modifications and variations which would occur to persons skilled in the art upon reading the foregoing description and which are not in the prior art.

What is claimed is:

1. An optical logic gate comprising:
a host material, wherein the host material has a plurality of air holes disposed throughout at least a portion thereof; and
at least two optical waveguides formed in the host material, wherein at least two of the optical waveguides are parallel to each other and are located sufficiently close to each other to permit propagation of an electromagnetic wave between the at least two of the optical waveguides.

2. The optical logic gate according to claim 1, wherein the at least two optical waveguides comprise three optical waveguides disposed in parallel, wherein a first two of the optical waveguides are coupled to input optical signals and the third optical waveguide is coupled to an output, and wherein the third optical waveguide is disposed between the first two of the optical waveguides.

3. The optical logic gate according to claim 2, wherein the third optical waveguide is i longitudinally offset relative to the first two of the optical waveguides.

4. The optical logic gate according to claim 1, wherein the at least two optical waveguides include at least one optical waveguide coupled to an optical signal and configured to control a logic function of the optical logic gate.

5. The optical logic gate according to claim 3, wherein the optical logic gate includes a P-I-N structure to effect control of the logic function.

6. The optical logic gate according to claim 1, further comprising an insulating substrate on which the host material is disposed.

7. The optical logic gate according to claim 1, wherein the optical logic gate is configured to perform one or more logic operations selected from the group consisting of: AND, NAND, OR, NOR, XOR, and XNOR.

8. The optical logic gate according to claim 1, further comprising a photodetector coupled to at least one end of at least one of the at least two optical waveguides and configured to provide an output.

9. The optical logic gate according to claim 1, wherein the host material comprises silicon.

10. The optical logic gate according to claim 1, wherein the plurality of air holes are disposed in a periodic arrangement.

11. The optical logic gate according to claim 10, wherein the plurality of air holes includes at least one plurality of air holes disposed close to at least one of the optical waveguides, wherein the at least one plurality of air holes includes air holes of a larger size than the air holes not included in the at least one plurality of air holes.

12. The optical logic gate according to claim 10, wherein the plurality of air holes are configured to produce slow light in at least one of the optical waveguides.

13. The optical logic gate according to claim 1, wherein the at least two optical waveguides comprise line defects in the host material.
